(19) United States
(12) Patent Application Publication
(10) Pub. No.: US 2010/0105330 A1
(43) Pub. Date: Apr. 29, 2010

(54) External roadcast display for a digital media player

(76) Inventors: Michael Solomon, New York, NY (US); Rishon Blumberg, New York, NY (US)

Correspondence Address: COOPER & DUNHAM, LLP, 30 Rockefeller Plaza, 20th Floor, NEW YORK, NY, 10112, US

(21) Appl. No.: 12/290,259

(22) Filed: Oct. 29, 2008

(51) Int. Cl. H04B 7/00

(52) U.S. Cl. 455/41.3

(57) ABSTRACT

A digital media player is connected to an external broadcast display system. The external broadcast system broadcasts metadata associated with the song and performer in play upon detection of metadata signals from the media player.

### FIELD OF THE INVENTION

The present disclosure relates generally to the field of digital media players, and more particularly, to an external broadcast display for a digital media player.

### BACKGROUND OF THE INVENTION

The popularity of digital media players, such as portable digital media players, personal computers as media players, and digital radio receivers, has grown significantly. A portable media player is currently a hard disk or flash memory-based device that is used to store and play back media files, such as audio or video files. A digital radio receiver receives and plays digital multicast programming. In addition to playing music and video files, the devices can display certain metadata, for example, when a song is in play, the name of the artist, the name of the song, the name of the album, the album cover artwork, the genre, and so forth can be viewed on a small display integrated into the device.

The popularity of digital media receivers is due to their superior sound quality. The popularity of using personal computers as digital media players is due to the convenience of storing many media files on one device, and the superior sound quality. The popularity of portable media devices is due to their ability to allow users to carry a relatively large number of audio and video files in a portable device. For example, the iPod® portable media players sold by Apple Computer, Inc. are small in size and provide many gigabytes of storage for audio and other files, enabling media collectors to create expansive libraries. Preferences and assortment of media collected on a portable media player can be seen as indicators of personal qualities, and sharing this information is a form of personal expression and a social interaction. Thus, where it is inappropriate or a user is unable to broadcast the song being listened to, the information regarding the song, album, and artist still is relevant. In addition, it is helpful for the listener to know the name, album, and artist if a song is playing and the listener cannot otherwise identify it.

Further, although external speakers project audio, there is no means to externally project the associated metadata. For example, a user can plug their iPod® music player or digital radio receiver into a set of external speakers. The music will play from the speakers, but the associated metadata can only be viewed on the tiny display integrated into the digital media player.

The popularity of digital media players and the desire of self-expression and information sharing gives rise to a need for a device that connects to the digital media player and externally displays the metadata associated with the file in play. Accordingly, there is a need for a way to externally broadcast metadata associated with the media file in play in order to provide an enhanced means of playback.

### SUMMARY OF INVENTION

To these and other ends, the present invention contemplates an external broadcast display system for a digital media player. The external broadcast display system for a digital media player comprises a transmitter for transmitting metadata signals from the digital media player, a receiver for receiving the transmitted metadata signals, a controller for converting the received metadata signals into output for a display and controlling the display in response to the output, and a display.

The transmitter and the receiver may be connected with a cable, or the transmitter may emit and the receiver may receive wireless signals, such as Wi-Fi (IEEE 802.11 technologies), Worldwide Interoperability for Microwave Access (WiMAX) Universal Mobile Telecommunications System (UMTS), Evolution-Data Optimized/Evolution-Data Only (EVDO), Bluetooth, infrared or other wireless communication systems all of which are well known in the art and may be designed and constructed according to the particular design goals of the given system by one of ordinary skill in the art. The display may be one or more of a light-emitting diode (LED) display, liquid crystal display (LCD), projection display, or a plasma display or other display, all of which are well known in the art and may be designed and constructed according to the particular design goals of the given system by one of ordinary skill in the art. The display may be of the segmented type, such as a seven-segment or fourteen-segment display, or in a matrix structure. The display may be incorporated into an article of clothing, a personal accessory, apparel, automobile accessory or a decorative home object. The digital media player may comprise a portable media player, a personal computer, or digital radio receiver.

The external broadcast display system for a digital media player comprises a digital media player, a cable for connecting the digital media player to a circuit, a circuit for detecting and converting metadata signals from the digital media player into output for a display and controlling the display in response to the output, and a display. The receiver, circuit, and display may be incorporated into an article of clothing, a personal accessory, apparel, automobile accessory, a decorative home object, or a variety of different objects, all of which are well known in the art and may be designed and constructed according to the particular design goals of the given system by one of ordinary skill in the art. The display may comprise one or more of a LED display, LCD, projection display, or plasma display. The display may be of the segmented type, or in a matrix structure. The digital media player may comprise a portable media player, digital radio receiver, or a personal computer.

The present invention further contemplates a method for externally broadcasting metadata from a digital media player which comprises transmitting metadata signals from a digital media player which correspond to the media played, receiving the metadata signals from the transmitter, converting the received metadata signals into output for a display, and displaying metadata signals corresponding to the media played. The display may comprise one or more of a LED display, LCD, projection display, or plasma display. The display may be of the segmented type, or in a matrix structure. The display may be incorporated into an article of clothing, a personal accessory, apparel, automobile accessory, or a decorative object for the home. The digital media player may comprise a portable media player, a digital radio receiver, or a personal computer.

### BRIEF DESCRIPTION OF THE DRAWINGS

The features of the present application can be more readily understood from the following detailed description with reference to the accompanying drawings wherein:

FIG. 1 illustrates an external broadcast display for a digital media player, according to one embodiment of the present invention;

FIG. 2 illustrates an external broadcast display for a digital media player, according to another embodiment of the present invention;

FIG. 3 is a flow chart illustrating a method for external broadcast display for a digital media player, according to one embodiment of the present invention;

FIG. 4a is a view of an external broadcast display incorporated into a personal accessory, such as a hat, according to one embodiment of the present invention;

FIG. 4b is a view of an external broadcast display incorporated into a personal accessory, such as a hat, according to another embodiment of the present invention;

FIG. 5a is a view of a external broadcast display system incorporated into a decorative object for the home, such as a television display, according to one embodiment of the present invention;

FIG. 5b is a view of a external broadcast display system incorporated into a decorative object for the home, such as a television display, according to another embodiment of the present invention;

FIG. 6a is a view of an external broadcast display system incorporated into an item of apparel, such as a t-shirt, according to one embodiment of the present invention;

FIG. 6b is a view of an external broadcast display system incorporated into an item of apparel, such as a t-shirt, according to another embodiment of the present invention;

FIG. 7a is a view of an external broadcast display system incorporated into a personal accessory, such as a badge, according to one embodiment of the present invention;

FIG. 7b is a view of an external broadcast display system incorporated into a personal accessory, such as a badge, according to another embodiment of the present invention.

FIG. 8a is a view of an external broadcast display system incorporated into an automobile accessory, such as an exterior bumper accessory, according to one embodiment of the present invention;

FIG. 8b is a view of an external broadcast display system incorporated into an automobile accessory, such as an exterior bumper accessory, according to another embodiment of the present invention.

FIG. 9a is a view of an external broadcast display system incorporated into an automobile accessory, such as a window decoration, according to one embodiment of the present invention; and

FIG. 9b is a view of an external broadcast display system incorporated into an automobile accessory, such as a window decoration, according to another embodiment of the present invention.

### DETAILED DESCRIPTION OF THE PREFERRED EMBODIMENTS

The present invention provides tools (in the form of methods and systems) for an external broadcast display system for a digital media device, and incorporating an external broadcast display system for a digital media device into various objects.

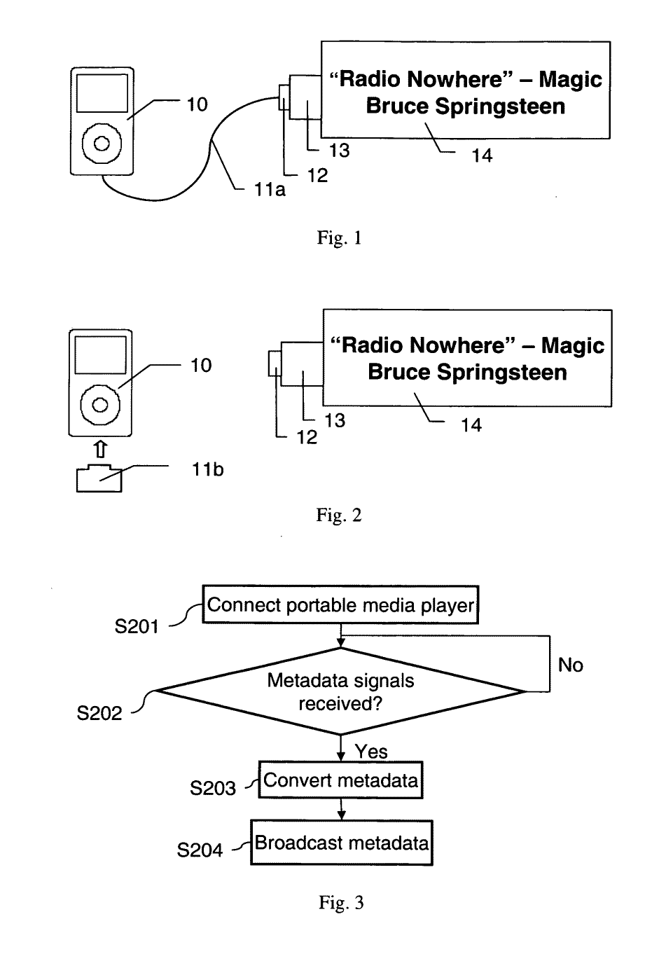

FIG. 1 illustrates an external broadcast display system for a digital media player, according to one embodiment of the present invention. The system includes a digital media player 10, transmitter 11a, a receiver 12, a controller 13, and a display 14.

In the present embodiment, the transmitter 11a is connected to a digital media player 10, such as an iPod®, by a cable. The transmitter 11a transmits metadata from the digital media player 10 corresponding to the media played. The receiver 12 receives metadata from the transmitter 11a, and the controller 13 converts the received metadata into output for a display and causes the display 14 to broadcast the converted metadata corresponding to the media played. The display 14, the receiver 12, and controller 13 may be incorporated into an item of apparel, such as a t-shirt, a personal accessory, such as a badge or hat, an automobile accessory, such as an interior window decoration or exterior bumper accessory, or a decorative object for the home by glue, stitch, hook and loop fastener (such as Velcro® brand hook and loop fastener), button, magnet, suction, or screw.

FIG. 2 illustrates an external broadcast display system for a digital media player, according to a second embodiment. The transmitter 11b is able to wirelessly transmit data using means such as Wi-Fi, WiMAX, UMTS, EVDO, Bluetooth, infrared or other wireless communication systems all of which are well known in the art and may be designed and constructed according to the particular design goals of the given system by one of ordinary skill in the art. The transmitter 11b is connected to the digital media player 10. The transmitter 11b transmits metadata from the digital media player 10 corresponding to the media played to the receiver 12. The receiver 12 receives metadata from the transmitter 11b. The controller 13 converts the received metadata into output for the display 14 and causes the display 14 to broadcast the converted metadata corresponding to the media played. The display 14, the receiver 12, and controller 13 may be incorporated into an item of apparel, such as a t-shirt, a personal accessory, such as a badge or hat, an automobile accessory, such as an interior window decoration or exterior bumper accessory, or a decorative object for the home by glue, stitch, hook and loop fastener, button, magnet, suction, or screw.

A method for broadcasting a display system for a digital media player, according to one embodiment of the present invention, will be discussed below with reference to FIGS. 1, 2 and 3. The transmitter 11a-b is connected to the digital media player, such as an iPod® music player (Step S201). The receiver 12 receives metadata signals from the digital media player via the transmitter 11a-b (Step S202). If metadata signals are received, the controller 13 converts the received metadata signals into output for the display 14 (Step S203), and causes the display 14 to broadcast the converted metadata received from the digital media player 10 (Step S204).

The external broadcast display system is preferably, but not necessarily, a complete device having electrical and aesthetic features. For example, the electrical features of the external broadcast display system may include a power source (such as, batteries, solar cells, transformers, and electrical adaptors for electrical outlets), means to transmit metadata from the digital media player 10 to the receiver 12, which may be a cable 11a or a wireless data transfer system 11b, a display 14, a receiver 12, and a controller 13. For example, the aesthetic features of the external broadcast display system may include the variety and attractiveness of the article that the display 14, receiver 12, and controller 13 are incorporated into, which can vary in color, texture, size, and style.

The external broadcast display system may be incorporated into a large variety of different objects, all of which are well known in the art and may be designed and constructed according to the particular design goals of the given system by one of ordinary skill in the art. The display 14, receiver 12, and controller 13 may be incorporated into the object with a magnet, or by gluing, stitching, hook and loop fastening, buttoning, suctioning, or screwing the unit into the object.

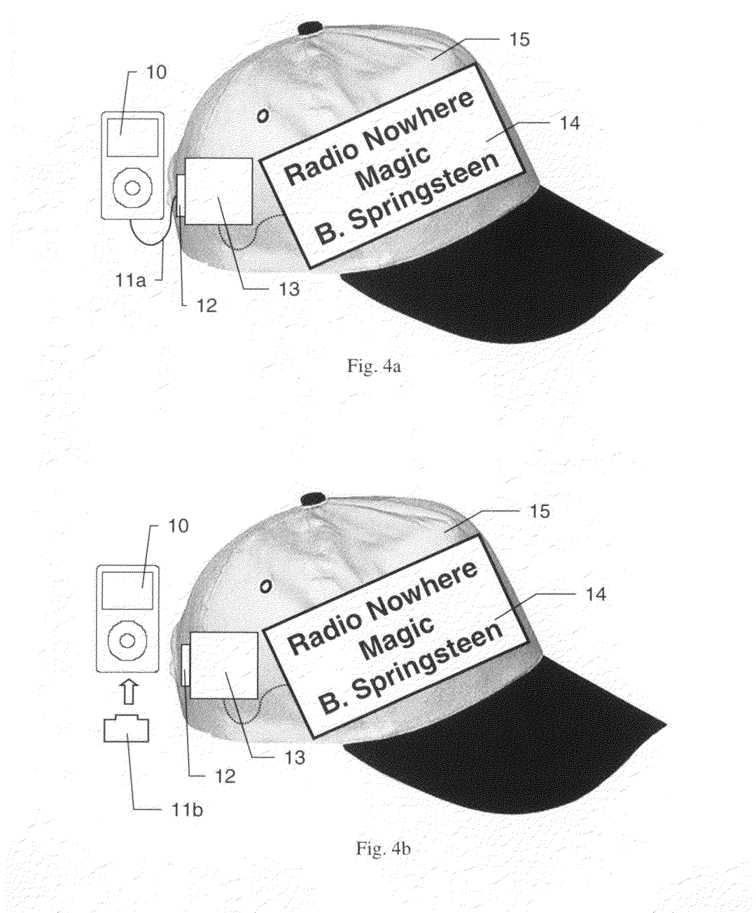

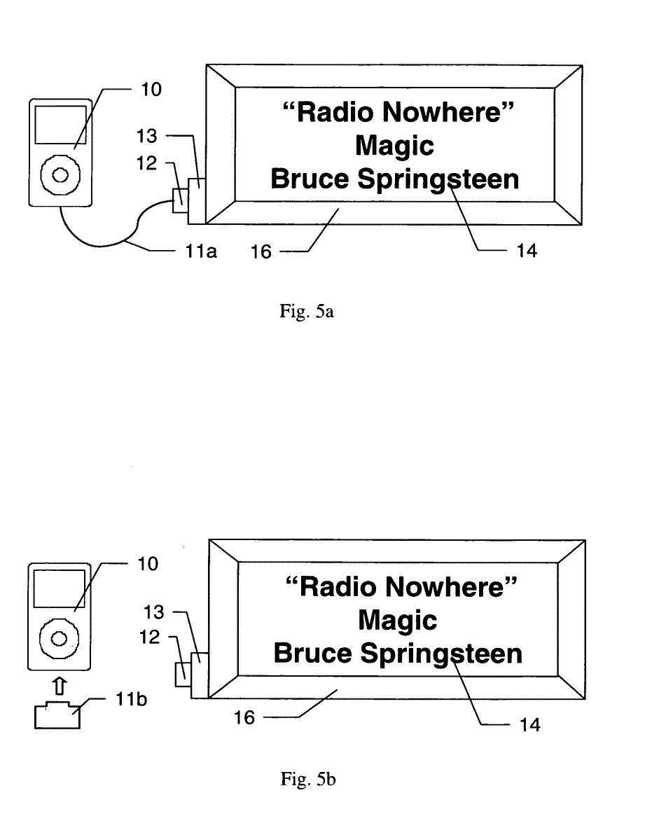

FIGS. 4a and 4b are views of an external broadcast display system incorporated into a hat 15, according to one embodiment of the present invention. Referring to FIG. 4a, the transmitter 11a is connected to the digital media player 10 and the receiver 12 by a cable. The transmitter 11a transmits metadata from the digital media player 10 corresponding to the media played to the receiver 12. The controller 13 converts the received metadata signals into output for a display 14 and causes the display 14 to broadcast the converted metadata corresponding to the media played.

Referring to FIG. 4b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

FIGS. 5a and 5b are views of an external broadcast display system incorporated into a decorative object for the home 16, according to one embodiment of the present invention. Referring to FIG. 5a, the transmitter 11a, is connected to the digital media player 10 and the receiver 12 by a cable. The transmitter 11a transmits metadata from the digital media player 10 corresponding to the media played to the receiver 12. The controller 13 converts the received metadata signals into output for a broadcast display 14 and causes the display 14 to broadcast the converted metadata corresponding to the media played.

Referring to FIG. 5b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

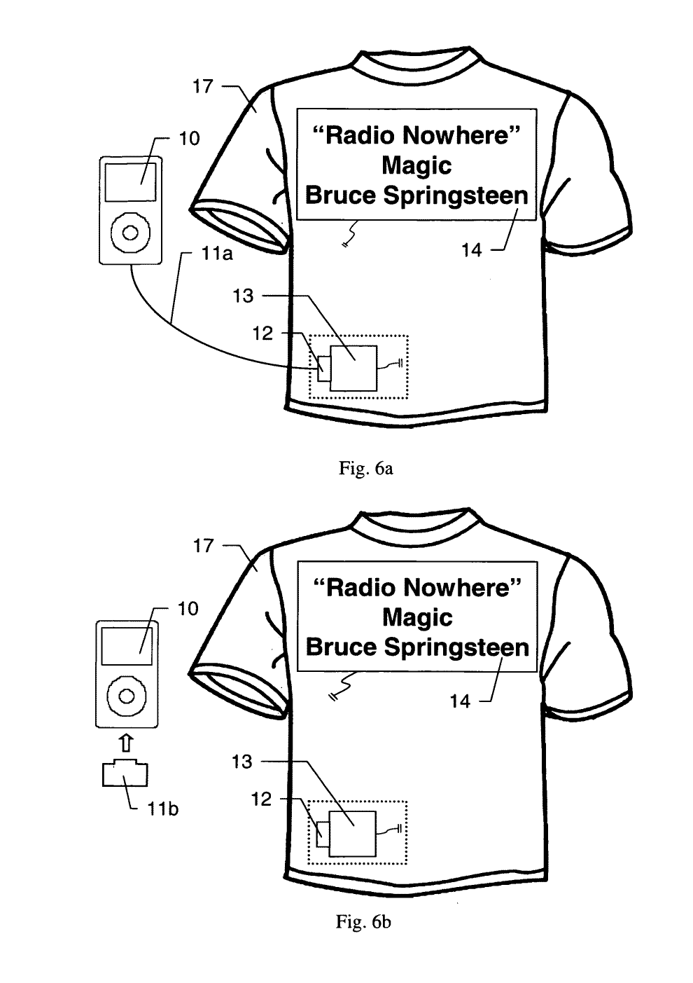

FIGS. 6a and 6b are views of an external broadcast display system incorporated into a t-shirt 17, according to one embodiment of the present invention. Referring to FIG. 6a, the transmitter 11a, is connected to the digital media player 10 and the receiver 12 by a cable. The transmitter 11a transmits metadata from the digital media player 10 corresponding to the media played to the receiver 12. The controller 13 converts the received metadata signals into output for a display 14 and causes the display 14 to broadcast the converted metadata corresponding to the media played.

Referring to FIG. 6b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

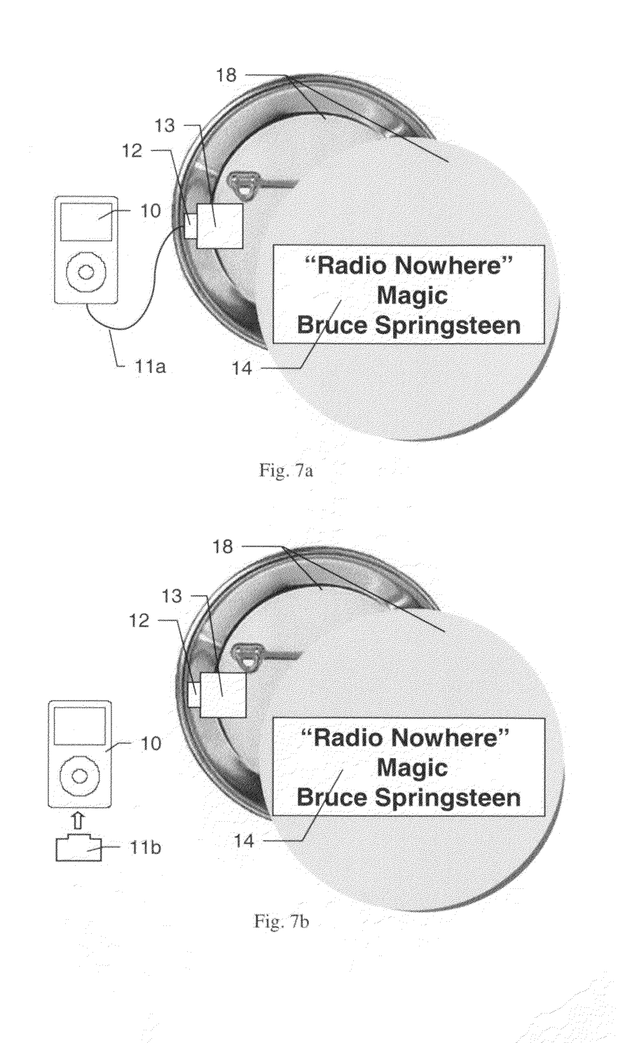

FIGS. 7a and 7b are views of an external broadcast display system incorporated into a badge 18, according to one embodiment of the present invention. Referring to FIG. 7a, the transmitter 11a, is connected to the digital media player 10 and the receiver 12 by a cable. The transmitter 11a transmits metadata from the digital media player 10 corresponding to the media played to the receiver 12. The controller 13 converts the received metadata signals into output for a display 14 and causes the display 14 to broadcast the converted metadata corresponding to the media played.

Referring to FIG. 7b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

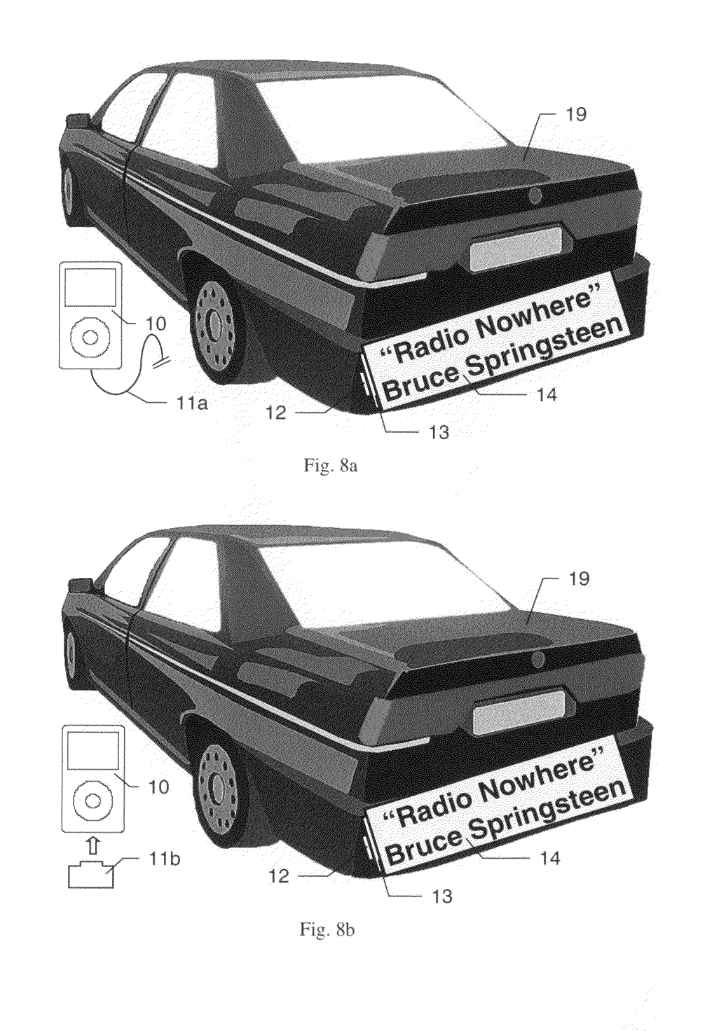

FIGS. 8a and 8b are views of an external broadcast display system incorporated into an automobile 19 accessory, according to one embodiment of the present invention. Referring to FIG. 8a, the transmitter 11a, is connected to the digital media player 10 and the receiver 12 by a cable. The transmitter 11a transmits metadata from the digital media player 10 corresponding to the media played to the receiver 12. The controller 13 converts the received metadata signals into output for a display 14 and causes the display 14 to broadcast the converted metadata corresponding to the media played.

Referring to FIG. 8b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

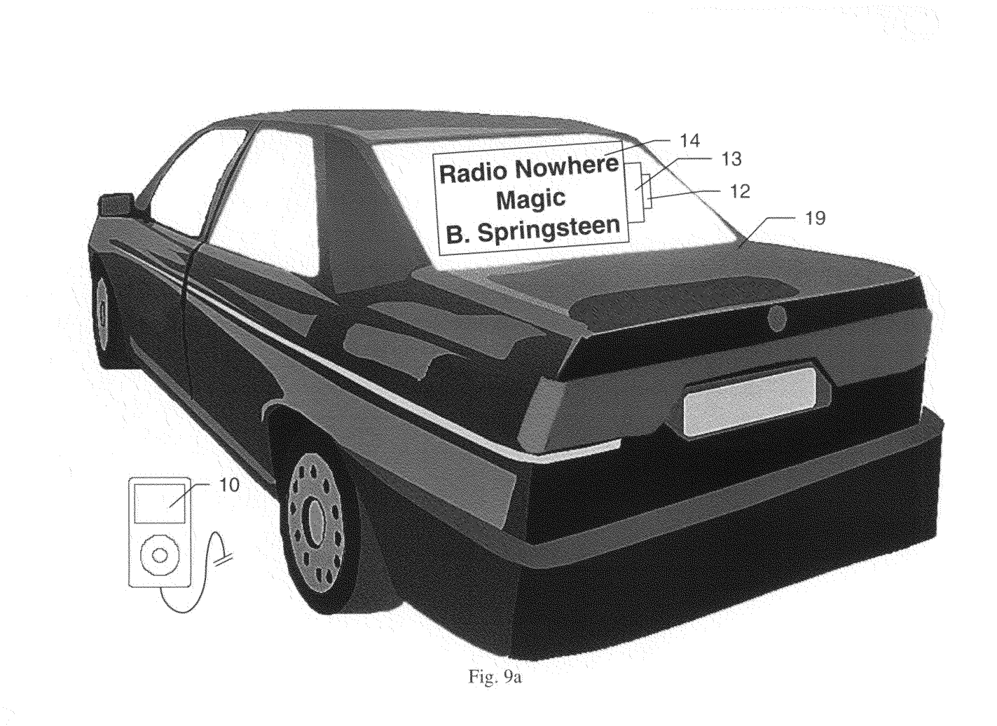

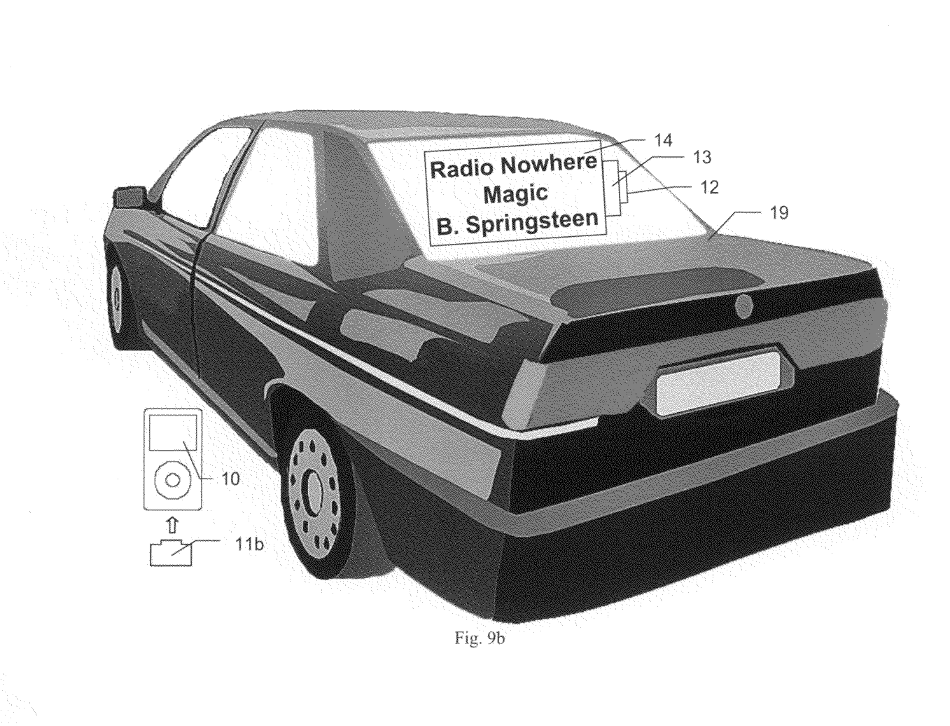

FIGS. 9a and 9b are views of an external broadcast display system incorporated into an automobile 19 accessory, according to one embodiment of the present invention. Referring to FIG. 9a, the transmitter 11a, is connected to the digital media player 10 and the receiver 12 by a cable. The transmitter 11a transmits metadata from the digital media player 10 corresponding to the media played to the receiver 12. The controller 13 converts the received metadata signals into output for a display 14 and causes the display 14 to broadcast the converted metadata corresponding to the media played.

Referring to FIG. 9b, the transmitter 11b, which is a wireless transmitting device, is connected to the digital media player 10. The transmitter 11b transmits metadata from the digital media player 10 corresponding to the media played to the receiver 12. The receiver 12 receives metadata from the transmitter 11b. The controller 13 converts the received metadata signals into output for a display 14 and causes the display 14 to broadcast the converted metadata corresponding to the media played.

Numerous additional modifications and variations of the present invention are possible in view of the above teachings.

What is claimed is:

1. An external broadcast display system for a digital media player, comprising:
a transmitter for transmitting metadata signals from the digital media player;
a receiver for receiving the transmitted metadata signals;
a controller for converting the received metadata signals into output for a display and controlling the broadcast display in response to the output.

2. The external broadcast display system of claim 1, wherein the transmitter is connected to the receiver by a cable.

3. The external broadcast display system of claim 1, wherein the transmitter emits and the receiver receives wireless signals.

4. The external broadcast display system of claim 3, wherein said wireless signals are Wi-Fi, WiMAX, UMTS, EVDO, Bluetooth, or infrared transmissions.

5. The external broadcast display system of claim 1, wherein the display is incorporated into an article of clothing, a personal accessory, apparel, automobile accessory, or a decorative home object.

6. The external broadcast display system of claim 1, wherein the display comprises one or more of a light-emitting diode display, liquid crystal display, projection display, or plasma display.

7. The external broadcast display system of claim 1, wherein the digital media player is a portable media player, personal computer, or a digital radio receiver.

8. An external broadcast display system for a digital media player, comprising:
a digital media player;
a circuit for detecting and converting metadata signals into output for a display and controlling the broadcast display in response to the output; and
a display.

9. The external broadcast display system of claim 8, wherein the display comprises one or more of a light-emitting diode display, liquid crystal display, projection display, or plasma display.

10. The external broadcast display system of claim 8, wherein the display is incorporated into an article of clothing, a personal accessory, apparel, automobile accessory, or a decorative home object.

11. The external broadcast display system of claim 8, wherein the digital media player is a portable media player, personal computer, or a digital radio receiver.

12. A method for externally broadcasting metadata from a digital media player, comprising:
transmitting metadata signals from a digital media player;
receiving the metadata signals from the transmitter;
converting the detected metadata signals into output for a broadcast display; and
controlling the display in response to the converted metadata signals.

13. A method according to claim 12, wherein the display is one or more of a light-emitting diode display, liquid crystal display, segmented liquid crystal display, projection display, or plasma display.

13. A method according to claim 12, wherein the display is incorporated into an article of clothing, a personal accessory, apparel, automobile accessory, or a decorative home object.

14. A method according to claim 12, wherein the digital media player is a portable media player, personal computer or a digital radio receiver.
